(19) United States
(12) Patent Application Publication
(10) Pub. No.: US 2024/0063970 A1
(43) Pub. Date: Feb. 22, 2024

(54) User Equipment and Methods for Blind Detection of Reference Signals in Idle Mode

(71) Applicant: TelefonaktiebolagetLMEricsson(publ), Stockholm (SE)

(72) Inventors: Sina Maleki, Malmö (SE); Andres Reial, Höllviken (SE); Ajit Nimbalker, Dublin, CA (US); llmiawan Shubhi, Malmö (SE)

(21) Appl. No.: 18/259,358

(22) PCT Filed: Jan. 13, 2022
(86) PCT No.: PCT/EP2022/050680

§ 371 Date: Jun. 26, 2023

Related U.S. Application Data
(60) Provisional application No. 63/138,147, filed on Jan. 15, 2021.

(51) Int. Cl. H04L 5/00; H04W 72/0453; H04L 1/00; H04W 68/02

(52) U.S. Cl. CPC H04L 5/0051; H04W 72/0453; H04L 1/0038; H04W 68/02

(57) ABSTRACT

A user equipment, UE, comprising a processor and a receiving module connected to the processor performs a method for detection of a reference signal in idle mode in a wireless communication system, the method comprising: determining whether a part of the reference signal is present, wherein the part of the reference signal comprise any one of a first symbol or a subset of the first symbol resources of the reference signal, a subcarrier of the reference signal, a subset frequency allocations of the reference signal, a part of reference signal with a smaller bandwidth than the total bandwidth of the reference signal, a subset of time or/and frequency resource elements of the reference signal, and adapting further detection of the reference signal based on the detection result on the part of the reference signal.

### TECHNICAL FIELD

Embodiments herein relate to a user equipment and methods therein for blind detection of reference signals. In particular, they relate to how to detect the presence of a reference signal efficiently in a wireless communication system.

### BACKGROUND

A Universal Mobile Telecommunications System (UMTS) is a third generation (3G) telecommunication network, which evolved from the second generation (2G) Global System for Mobile Communications (GSM). Specifications for the Evolved Packet System (EPS), also called a Fourth Generation (4G) network or Long Term Evolution (LTE), have been completed within the 3rd Generation Partnership Project (3GPP) and this work continues in the coming 3GPP releases, for example to specify a Fifth Generation (5G) New Radio (NR) network.

The 3GPP is defining technical specifications for 5G NR. In release 15 (Rel-15) NR, a user equipment (UE) can be configured with up to four carrier bandwidth parts (BWPs) in the downlink with a single downlink carrier bandwidth part being active at a given time. A UE can be configured with up to four carrier bandwidth parts in the uplink with a single uplink carrier bandwidth part being active at a given time. If a UE is configured with a supplementary uplink, the UE can additionally be configured with up to four carrier bandwidth parts in the supplementary uplink with a single supplementary uplink carrier bandwidth part being active at a given time.

For a carrier bandwidth part with a given numerology μᵢ, a contiguous set of physical resource blocks (PRBs) are defined and numbered from 0 to N_{BWP}_{ᵢ}^{size}−1, where i is the index of the carrier bandwidth part. A resource block (RB) is defined as 12 consecutive subcarriers in the frequency domain.

Multiple orthogonal frequency-division multiplexing (OFDM) numerologies, pi, are supported in NR as given by Table 1, where the subcarrier spacing, Δf, and the cyclic prefix for a carrier bandwidth part are configured by different higher layer parameters for downlink (DL) and uplink (UL), respectively.

TABLE 1
Supported transmission numerologies.

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Physical Channels

A downlink physical channel corresponds to a set of resource elements carrying information originating from higher layers. The following downlink physical channels are defined:
Physical Downlink Shared Channel, PDSCH
Physical Broadcast Channel, PBCH
Physical Downlink Control Channel, PDCCH

PDSCH is the main physical channel used for unicast downlink data transmission, but also for transmission of random access response (RAR), certain system information blocks, and paging information. PBCH carries the basic system information, required by the UE to access the network. PDCCH is used for transmitting downlink control information (DCI), mainly scheduling decisions, required for reception of PDSCH, and for uplink scheduling grants enabling transmission on PUSCH.

An uplink physical channel corresponds to a set of resource elements carrying information originating from higher layers. The following uplink physical channels are defined:
Physical Uplink Shared Channel(PUSCH)
Physical Uplink Control Channel (PUCCH)
Physical Random Access Channel (PRACH)

PUSCH is the uplink counterpart to the PDSCH. PUCCH is used by UEs to transmit uplink control information, including Hybrid automatic repeat request (HARQ) acknowledgements, channel state information reports, etc. PRACH is used for random access preamble transmission.

NR Reference Symbols

The ultra-lean design principle in NR aims to minimize the always-on transmissions that exist in earlier systems, e.g. LTE cell-specific reference signal (CRS) reference symbols. Instead, NR provides reference symbols such as Synchronization Signal Blocks (SSBs) on a periodic basis, e.g. by default once every 20 ms. In addition, for connected mode UEs, typically a set of reference symbols are provided for optimal link performance. Some of these reference symbols are clarified below.

Channel State Information-Reference Signal (CSI-RS) for Tracking

A UE in Radio Resource Control (RRC) connected mode is expected to receive from the network (NVV) an RRC layer UE specific configuration with a NZP-CSI-RS-ResourceSet message configured including a parameter trs-Info. For a NZP-CSI-RS-ResourceSet configured with the higher layer parameter trs-Info set to “true”, the UE shall assume the antenna port with the same port index of the configured Non-zero power (NZP) CSI-RS resources in the NZP-CSI-RS-ResourceSet is the same.
For frequency range 1 (FR1), the UE may be configured with one or more NZP CSI-RS set(s), where an NZP-CSI-RS-ResourceSet consists of four periodic NZP CSI-RS resources in two consecutive slots with two periodic NZP CSI-RS resources in each slot. If no two consecutive slots are indicated as downlink slots by tdd-UL-DL-ConfigurationCommon message or tdd-UL-DL-ConfigDedicated message, then the UE may be configured with one or more NZP CSI-RS set(s), where an NZP-CSI-RS-ResourceSet consists of two periodic NZP CSI-RS resources in one slot.
For frequency range 2 (FR2), the UE may be configured with one or more NZP CSI-RS set(s), where an NZP-CSI-RS-ResourceSet consists of two periodic CSI-RS resources in one slot or with an NZP-CSI-RS-ResourceSet of four periodic NZP CSI-RS resources in two consecutive slots with two periodic NZP CSI-RS resources in each slot.

A UE configured with NZP-CSI-RS-ResourceSet(s) configured with higher layer parameter trs-Info may have the CSI-RS resources configured as:
Periodic, with the CSI-RS resources in the NZP-CSI-RS-ResourceSet configured with same periodicity, bandwidth and subcarrier location
Periodic CSI-RS resource in one set and aperiodic CSI-RS resources in a second set, with the aperiodic CSI-RS and periodic CSI-RS resource having the same bandwidth with same RB location and the aperiodic CSI-RS being ‘QCL-Type-A’ and ‘QCL-Type-D’, where applicable, with the periodic CSI-RS resources. For frequency range 2, the UE does not expect that the scheduling offset between the last symbol of the PDCCH carrying the triggering DCI and the first symbol of the aperiodic CSI-RS resources is smaller than the UE reported ThresholdSched-Offset. The UE shall expect that the periodic CSI-RS resource set and aperiodic CSI-RS resource set are configured with the same number of CSI-RS resources and with the same number of CSI-RS resources in a slot. For the aperiodic CSI-RS resource set, if triggered, and if the associated periodic CSI-RS resource set is configured with four periodic CSI-RS resources with two consecutive slots with two periodic CSI-RS resources in each slot, the higher layer parameter aperiodicTriggeringOffset indicates the triggering offset for the first slot for the first two CSI-RS resources in the set.

A UE does not expect to be configured with a CSI-ReportConfig that is linked to a CSI-ResourceConfig containing an NZP-CSI-RS-ResourceSet configured with trs-Info and with the CSI-ReportConfig configured with the higher layer parameter timeRestrictionForChannelMeasurements set to ‘configured’.

A UE does not expect to be configured with a CSI-ReportConfig with the higher layer parameter reportQuantity set to other than ‘none’ for aperiodic NZP CSI-RS resource set configured with trs-Info.

A UE does not expect to be configured with a CSI-ReportConfig for periodic NZP CSI-RS resource set configured with trs-Info.

A UE does not expect to be configured with a NZP-CSI-RS-ResourceSet configured both with trs-Info and repetition.

Each CSI-RS resource, defined in Clause 7.4.1.5.3 of [4, TS 38.211], is configured by the higher layer parameter NZP-CSI-RS-Resource with the following restrictions:
the time-domain locations of the two CSI-RS resources in a slot, or of the four CSI-RS resources in two consecutive slots, which are the same across two consecutive slots, as defined by higher layer parameter CSI-RS-resourceMapping, is given by one of
   l∈{4,8}, l∈{5,9}, or l∈{6,10} for frequency range 1 and frequency range 2,
   l∈{0,4}, l∈{1,5}, l∈{2,6}, l∈{3,7}, l∈{7,11}, l∈{8,12} or l∈{9,13} for frequency range 2.
a single port CSI-RS resource with density ρ=3 given by Table 7.4.1.5.3-1 from [4, TS 38.211] and higher layer parameter density configured by CSI-RS-ResourceMapping.
the bandwidth of the CSI-RS resource, as given by the higher layer parameter freqBand configured by CSI-RS-ResourceMapping, is the minimum of 52 and N_{BWP}_{ᵢ}^{size} resource blocks, or is equal to N_{BWP}_{ᵢ}^{size} resource blocks. For operation with shared spectrum channel access, freqBand configured by CSI-RS-ResourceMapping, is the minimum of 48 and N_{BWP}_{ᵢ}^{size} resource blocks, or is equal to N_{BWP}_{ᵢ}^{size} resource blocks.
the UE is not expected to be configured with the periodicity of 2^{μ}×10 to slots if the bandwidth of CSI-RS resource is larger than 52 resource blocks.
the periodicity and slot offset for periodic NZP CSI-RS resources, as given by the higher layer parameter periodicityAndOffset configured by NZP-CSI-RS-Resource, is one of 2^{μ}Xₚ slots where xₚ=10, 20, 40, or 80 and where p is defined in Clause 4.3 of [4, TS 38.211].
same powerControlOffset and powerControlOffsetSS given by NZP-CSI-RS-Resource value across all resources.

NZP CSI-RS

The UE can be configured with one or more NZP CSI-RS resource set configuration(s) as indicated by the higher layer parameters CSI-ResourceConfig, and NZP-CSI-RS-ResourceSet. Each NZP CSI-RS resource set consists of K≥1 NZP CSI-RS resource(s).

The following parameters for which the UE shall assume non-zero transmission power for CSI-RS resource are configured via the higher layer parameter NZP-CSI-RS-Resource, CSI-ResourceConfig and NZP-CSI-RS-ResourceSet for each CSI-RS resource configuration:
nzp-CSI-RS-Resourceld determines CSI-RS resource configuration identity.
periodicityAndOffset defines the CSI-RS periodicity and slot offset for periodic/semi-persistent CSI-RS. All the CSI-RS resources within one set are configured with the same periodicity, while the slot offset can be same or different for different CSI-RS resources.
resourceMapping defines the number of ports, CDM-type, and OFDM symbol and subcarrier occupancy of the CSI-RS resource within a slot that are given in Clause 7.4.1.5 of [4, TS 38.211].
nrofPorts in resourceMapping defines the number of CSI-RS ports, where the allowable values are given in Clause 7.4.1.5 of [4, TS 38.211].
density in resourceMapping defines CSI-RS frequency density of each CSI-RS port per PRB, and CSI-RS PRB offset in case of the density value of ½, where the allowable values are given in Clause 7.4.1.5 of [4, TS 38.211]. For density ½, the odd/even PRB allocation indicated in density is with respect to the common resource block grid.
cdm-Type in resourceMapping defines CDM values and pattern, where the allowable values are given in Clause 7.4.1.5 of [4, TS 38.211].
powerControlOffset: which is the assumed ratio of PDSCH EPRE to NZP CSI-RS EPRE when UE derives CSI feedback and takes values in the range of [−8, 15] dB with 1 dB step size.
powerControlOffsetSS: which is the assumed ratio of NZP CSI-RS EPRE to SS/PBCH block EPRE.
scramblinglD defines scrambling ID of CSI-RS with length of 10 bits.
BWP-Id in CSI-ResourceConfig defines which bandwidth part the configured CSI-RS is located in.
repetition in NZP-CSI-RS-ResourceSet is associated with a CSI-RS resource set and defines whether UE can assume the CSI-RS resources within the NZP CSI-RS Resource Set are transmitted with the same downlink spatial domain transmission filter or not as described in Clause 5.1.6.1.2. and can be configured only when the higher layer parameter reportQuantity associated with all the reporting settings linked with the CSI-RS resource set is set to ‘cri-RSRP’, ‘cri-SINR’ or ‘none’.
qcl-InfoPeriodicCSI-RS contains a reference to a TCI-State indicating QCL source RS(s) and QCL type(s). If the TCI-State is configured with a reference to an RS with ‘QCL-TypeD’ association, that RS may be an SS/PBCH block located in the same or different CC/DL BWP or a CSI-RS resource configured as periodic located in the same or different CC/DL BWP.
trs-Info in NZP-CSI-RS-ResourceSet is associated with a CSI-RS resource set and for which the UE can assume that the antenna port with the same port index of the configured NZP CSI-RS resources in the NZP-CSI-RS-ResourceSet is the same as described in Clause 5.1.6.1.1 and can be configured when reporting setting is not configured or when the higher layer parameter reportQuantity associated with all the reporting settings linked with the CSI-RS resource set is set to ‘none’.

All CSI-RS resources within one set are configured with same density and same nrofPorts, except for the NZP CSI-RS resources used for interference measurement.

The UE expects that all the CSI-RS resources of a resource set are configured with the same starting resource block (RB) and number of RBs and the same code division multiplexing (CDM) type.

The bandwidth and initial common resource block (CRB) index of a CSI-RS resource within a BWP, as defined in Clause 7.4.1.5 of [4, TS 38.211], are determined based on the higher layer parameters nrofRBs and startingRB, respectively, within the CSI-FrequencyOccupation IE configured by the higher layer parameter freqBand within the CSI-RS-ResourceMapping IE. Both nrofRBs and startingRB are configured as integer multiples of 4 RBs, and the reference point for startingRB is CRB 0 on the common resource block grid. If startingRB<N_{BWP}^{start}, the UE shall assume that the initial CRB index of the CSI-RS resource is N_{initial RB}=N_{BWP}^{start}, otherwise N_{initial RB}=startingRB. If nrofRBs>N_{BWP}^{size}+N_{BWP}^{start}−N_{initial RB} the UE shall assume that the bandwidth of the CSI-RS resource is N_{CSI-RS}^{BW}=N_{BWP}^{size}+N_{BWP}^{start}−N_{initial RB}, otherwise N_{CSI-RS}^{BW}=nrofRBs. In all cases, the UE shall expect that N_{CSI-RS}^{BW}≥min (24, N_{BWP}^{size}).

The following are short explanations for some IE parameters, for detailed information, see TS 38.214.

The IE NZP-CSI-RS-Resource is used to configure Non-Zero-Power (NZP) CSI-RS transmitted in the cell where the IE is included, which the UE may be configured to measure on.

The IE NZP-CSI-RS-Resourceld is used to identify one NZP-CSI-RS-Resource.

The IE NZP-CSI-RS-ResourceSet is a set of Non-Zero-Power (NZP) CSI-RS resources (their IDs) and set-specific parameters.

The IE NZP-CSI-RS-ResourceSetId is used to identify one NZP-CSI-RS-ResourceSet.

The IE CSI-ResourceConfig defines a group of one or more NZP-CSI-RS-ResourceSet, CSI-IM-Resource Set and/or CSI-SSB-ResourceSet.

The IE CSI-ResourceConfigId is used to identify a CSI-ResourceConfig.

The IE CSI-ResourcePeriodicityAndOffset is used to configure a periodicity and a corresponding offset for periodic and semi-persistent CSI resources, and for periodic and semi-persistent reporting on PUCCH. Both the periodicity and the offset are given in number of slots. The periodicity value slots4 corresponds to 4 slots, slots5 corresponds to 5 slots, and so on.

The IE CSI-RS-ResourceConfigMobility is used to configure CSI-RS based RRM measurements.

The IE CSI-RS-ResourceMapping is used to configure the resource element mapping of a CSI-RS resource in time- and frequency domain.

### SUMMARY

As part of developing embodiments herein problems were identified and will first be discussed.

In NR, the UE may be provided with a number of periodic CSI-RS configurations, e.g., Tracking Reference Signal (TRS) in RRC_connected mode used for fine Time/Frequency (T/F) tracking, channel estimation, etc. In Rel 17 the network node can provide one or more of such TRS/CSI-RS occasions to the idle UEs i.e., UEs which are in RRC_Idle/Inactive states. A UE may also become aware of such occasions in the connected mode and keep them and potentially exploit them when the UE transitions to idle mode, e.g., to lower the power consumption associated with PO monitoring. In both cases, for the UE to be able to exploit such TRS/CSI-RS occasions, it is important that the UE is also aware that if those signals are actually transmitted in the TRS/CSI-RS occasions. This may not be always the case, as the network node may not be obliged to transmit TRS/CSI-RS in the TRS/CSI-RS occasions. Blind detection (BD) of TRS/CSI-RS in TRS/CSI-RS occasion can remain as an option for UE implementation, and particularly it is useful for all the idle UEs in all releases, e.g., Rel15/16 where the TRS/CSI-RS occasions are not explicitly provided to idle UEs.

The blind detection of TRS as a general concept has been discussed in the context of enabling alternative measurements. However, the detail of how such a blind detection should be performed or optimized in terms of power savings is not disclosed. Furthermore, it is not disclosed how the UE should decide to perform blind detection or skip it. Power saving for blind detection is particularly important, since if the UE does not detect a TRS/CSI-RS, it has to employ other Reference Symbols (RSs), e.g., SSB, which in turn means additional power consumption.

Note that in addition to provision of TRS to idle UEs to e.g., exploit by having access to additional RSs before a Paging Occasion (PO) and thereby achieve power saving by skipping some of the SSBs, there are discussions to use TRS as a paging early indicator in idle mode, i.e., a signal which is transmitted by the network node before a PO indicating to the UE if there is or not a paging in the upcoming PO associated to the UE. In this case, the development of power efficient techniques to detect TRS as paging early indicator is also important.

Therefore, there is a need for methods with which the UE can detect the presence of a reference signal e.g. TRS/CSI-RS or detect a reference signal e.g. TRS as a paging early indicator in an energy efficient manner.

According to an aspect of embodiments herein, the object is achieved by a method performed in a UE for detection of a reference signal e.g. TRS/CSI-RS.

According to embodiments herein, the UE may be configured to determine whether a part of the reference signal is present. The part of the reference signal may comprise any one of a first symbol or a subset of the first symbol resources of the reference signal, a subcarrier of the reference signal, a subset frequency allocations of the reference signal, a part of reference signal with a smaller bandwidth than the total bandwidth of the reference signal, a subset of time or/and frequency resource elements of the reference signal. For example, the UE may detect a reference signal e.g. TRS/CSI-RS in only the first symbol of the TRS/CSI-RS occasion. If there is no reference signal TRS detected, e.g. based on a detection threshold, the UE may skip buffering or detecting the rest of the symbols of the TRS/CSI-RS occasion. In this way, the detection power consumption is reduced.

According to some embodiments, the UE may be configured to skip detecting a number of symbols of the reference signal occasion based on the processing time required to detect the reference signal.

According to some embodiments, the UE may be configured to detect at a subset of the reference signal frequency allocation, e.g., one subcarrier, or a smaller BW than the total reference signal bandwidth.

According to some embodiments, the UE may be configured to adapt further detection of the reference signal based on the detection result on the part of the reference signal. That is the UE may adapt the detection strategy based on the initial partial detection results. The UE may be configured to detect at least the first symbol of the reference signal and assess the detection probability, e.g. based on a detection metric like the correlator output magnitude.

If the metric is below a first threshold, the UE may decide that no reference signal TRS is present and revert to legacy procedures; any further detection is omitted. If the metric is above a second threshold, the UE may decide that the reference signal TRS is present and terminate the BD process and proceed with utilizing the TRS. If the metric is between the first and second thresholds, the UE may collect additional TRS symbols and perform further detection using aggregated samples from multiple symbols. The first and second thresholds may be adapted based on the estimated SINR. In one embodiment, the first threshold may be lower and the second threshold may be higher for lower SINR. The same principle may be applied after initially detecting 2 or more symbols, or applied progressively as more symbols are collected, where the first and second thresholds may depend on the number of symbols collected.

According to some embodiments, the UE may set a first detection performance which needs to be satisfied, e.g., the missed detection rate for the reference signal TRS/CSI-RS detection should be lower than a first threshold, or the false alarm rate for the reference signal TRS/CSI-RS detection should be lower than a second threshold. Based on the type of employed detector or channel conditions, the UE may decide how much T/F resources of the reference signal are required to receive or collect for the detection, or if detection of the first symbol or a subset of the first symbol resources is sufficient, to fulfill the first detection performance.

According to some embodiments, the UE may determine the number of required REs to achieve a required detection performance based on a combination over T/F domains, i.e. by selecting the receiver BW and the number of symbols that provide the required number of REs. The UE may further be configured to compare multiple combinations of BW and symbols and select the one providing the required number of REs with minimal energy consumption.

According to some embodiments, the UE may use a different receiver mode, e.g., a low power receiver mode than the normal mode, i.e., the mode used for paging monitoring for TRS detection.

According to some embodiments, the UE may detect a reference signal based on energy detection or feature detection.

According to some embodiments, the UE may implement multiple detectors and choose the one to use based on one or more factors such as a SINR threshold, or channel condition.

In other words, according to embodiments herein, the UE adapts the time and BW span of a reference signal resources or the number of symbols needed to receive or capture for detection of the presence of a reference signal, including progressive adaptation during an ongoing blind detect instance, to meet a detection performance targets, depending on factors like Signal to Interference plus Noise Ratio (SINR), target Pmd/Pfa, etc. By adapting the detection strategy based on any one or a combination of initial partial detection results, using lower power receiver mode etc., the blind detection of a reference signal is power and/or energy efficient. For example, the UE can achieve power saving by limiting the detection time, e.g., by using 1 or 2 symbols instead of 4, or limiting the BW, or by employing a detect strategy which is power efficient such as energy detection or employing T/F correlators. For example, the receiver operation span in time (symbols) and frequency (BW) dimensions is selected so as to expend minimal (as far as practically feasible) energy while collecting the required number of samples and/or REs for the requisite receiver processing.

According to some embodiments herein, the UE may further be configured to determine whether to blindly detect a reference signal e.g. TRS/CSI-RS or not.

The UE may determine whether to perform blind detection of a reference signal based on any one or a combination of the associated power consumption of the blind detection, the channel conditions, the probability of a reference signal being present, the presence of a reference signa as a paging early indicator etc.

For example, the UE may determine whether to perform blind detection of a reference signal based on whether the additional BD-related energy consumption is justified in the context of full receiver operation. The decision may be based on the expected BD energy cost, on current SINR, or on the probability of a reference signal TRS being present, etc.

Embodiments herein provide methods and mechanisms with which the UE can detect whether a reference signal TRS/CSI-RS is present in idle mode, and if present, then utilize them in order to lower the power consumption associated with monitoring a PO by reducing the total time the UE needs to be out of deep sleep state for the purpose of preparing the receiver for PO reception. For example, the UE based on some conditions determines that there is a need to measure two SSBs before a PO, e.g., for AGC, T/F synchronization, etc. As such in a benchmark operation, the UE needs to measure the first SSB, and then the second SSB, and then monitor PO. Additionally, the UE detects that there is a TRS either between the first SSB and the second SSB (i.e., a first TRS), or after the second SSB (i.e. a second TRS). Therefore, for example the UE can employ the first SSB and the first TRS for measurements, lowering the preparation time before the PO, and thereby gaining more sleep time and save power. Alternatively, the UE could also employ the first TRS and the second SSB, or the second SSB and second TRS for preparation before PO. Preparation may be e.g., AGC, T/F synchronization, cell reselection measurements, etc.

The proposed methods and mechanisms according to embodiments herein enables the UE to detect the presence of a reference signal e.g. TRS/CSI-RS in idle mode blindly and with low power consumption, which in turn enables the UE to reduce its overall power consumption associated with idle mode paging monitoring.

Therefore, embodiments herein provide a method for UE to detect a reference signal presence or detect a reference signal as paging early indicator in an energy efficient manner in the wireless communication system.

### BRIEF DESCRIPTION OF THE DRAWINGS

Examples of embodiments herein are described in more detail with reference to attached drawings in which:

FIG. 1 illustrating a wireless communication system in which embodiments herein may be implemented in;

FIG. 2 is a flow chart illustrating a method performed in a UE according one embodiment herein;

FIG. 3 is a schematic block diagram illustrating one embodiment of a UE.

### DETAILED DESCRIPTION

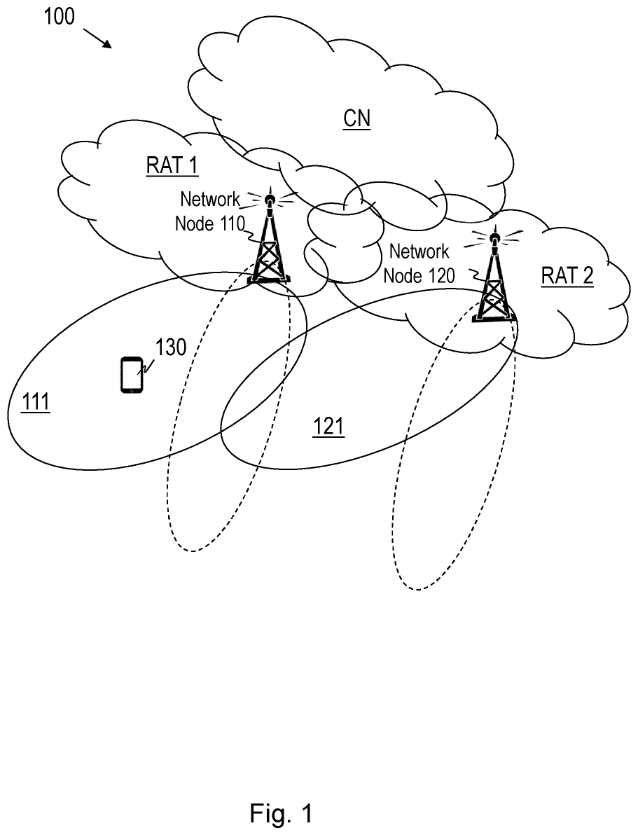

FIG. 1 is a schematic overview depicting a wireless communication system 100 in which embodiments herein may be implemented. The wireless communication system 100 may comprise any wireless system or cellular network, such as a Long Term Evolution (LTE) network, any 3^{rd} Generation Partnership Project (3GPP) cellular network, a Fourth Generation (4G) network, a Fifth Generation (5G) or NR network etc.

In the wireless communication system 100, wireless communication devices e.g. a user equipment 130 such as a mobile station or terminal, a wireless terminal communicate via one or more Radio Access Technology e.g. RAT 1, RAT2 to one or more core networks (CN). It should be understood by the skilled in the art that “wireless communication device” is a non-limiting term which means any terminal, wireless communication terminal, user equipment, Machine Type Communication (MTC) device, IoT device, Device to Device (D2D) terminal, or node e.g. smart phone, laptop, mobile phone, sensor, relay, mobile tablets or even a small base station communicating within a cell. The terms “user equipment”, “UE” and “wireless communication device” are used interchangeable herein.

Network nodes operate in the wireless communication networks such as a first network node 110 and a second network node 120. The first network node 110 provides radio coverage over a geographical area, a cell area or a service area 111, which may also be referred to as a beam or a beam group where the group of beams is covering the service area of a first radio access technology RAT 1, such as 5G, LTE, LTE-M, Wi-Fi or similar. The second network node 120 provides radio coverage over a geographical area, a service area 121, which may also be referred to as a beam or a beam group where the group of beams is covering the service area of a second radio access technology RAT 2, such as 5G, LTE, LTE-M, Wi-Fi or similar. The service areas 111 and 121 for e.g. LTE and NR, may overlap at some area. The first and second network nodes 110, 120 may be refereed as eNB, gNB etc.

According to embodiments herein, a scenario is considered where a communication device, e.g. the UE 130, is aware of the potential occasions of a reference signal such as TRS/CSI-RS in idle mode. The idle mode may also be referred to as RRC_idle/inactive mode or state. Typically, the network node e.g. the network node 110, may or may not transmit TRS/CSI-RS in a TRS/CSI-RS occasion. The awareness may have come either directly because of the network node 110 providing the information regarding the potential occasions to the idle UEs, e.g., through System Information (SI) broadcasting, or the UE may have learned the occasions e.g., during RRC_connected, or there was a paging recently indicating that there are some UEs in connected mode within the cell and thereby there is a high chance that TRS is transmitted. Nevertheless, the UE may not be aware of the actual transmission of TRS/CSI-RS in a TRS/CSI-RS occasion during idle mode, and as such it needs to detect their presence, herein referred to as blind detection. Furthermore, the network node 110 may provide to the idle UE the chance or probability of a reference signal such as TRS being present, e.g., as a percentage of time, e.g., 80% of the time as part of the provision of TRS occasions. This can be either an explicit minimum percentage of the time that TRS is present, or based on a pre-configuration, e.g., the network node is not expected to provide TRS occasions if the chance of TRS being present is less than a first threshold. Furthermore, the indication may be more detailed, e.g., if the chance of TRS being present is applicable to all RRC states or receiver operation modes, i.e. both idle and connected modes, or only to one of them. Alternatively, the UE 130 can acquire the chance of TRS being present in the idle mode, or both idle and connected mode based on history.

Moreover, the network node may provide a configuration of a reference signal e.g. TRS/CSI-RS to the idle UEs as a paging early indicator. Paging early indicator is a signal transmitted by the network node before one or more POs indicating e.g., if the UE should monitor paging in its upcoming PO. In this case, also the UE needs to blindly detect whether this reference signal TRS/CSI-RS is present.

In a benchmark detection approach, the UE can receive TRS/CSI-RS signals as if it is actually transmitted, then perform a detection on the full-range signal, i.e. the whole configured TRS/CSI-RS with full BW and/or all symbols, to see if it is actually present or not. Furthermore, based on the result, the UE decides if it needs to process additional signals, e.g., additional SSBs, if TRS is not detected.

To blindly detect the presence of a reference signal TRS, the UE may correlate the received signal with the expected TRS pattern in time or frequency domain. In general, if the correlation result is above a specific threshold, the UE may note that the TRS is present, if not, then the UE assumes there is no TRS signal present at this time. In general, known methods for signal detection may be used, e.g. T- or F-domain matched filter configured with the expected TRS sequences, or any other correlator or detector architectures. The reference sequences are configured to match the sampling rate, Bandwidth (BW), Resource Element (RE) pattern, etc. used for detection in the relevant domain.

In some situations, e.g. high Doppler or high dispersion, the detection is performed by correlating subsets of samples or REs coherently only within the determined coherence time/BW and combining the coherent correlation outputs non-coherently.

According to embodiments herein, the detailed mechanisms with which the UE can blindly detect a reference signal such as TRS/CSI-RS in a power efficient way, is first discussed, and then the mechanisms with which the UE can decide whether to perform blind detection (BD), e.g., to achieve power saving with respect to using only SSBs for paging monitoring are discussed.

Note that in the examples below, it is focused on periodic TRS, nevertheless, the disclosed methods can be easily applied to other types of reference signal such as CSI-RS.

### Aspect 1: Power Efficient Blind Detection of TRS/CSI-RS

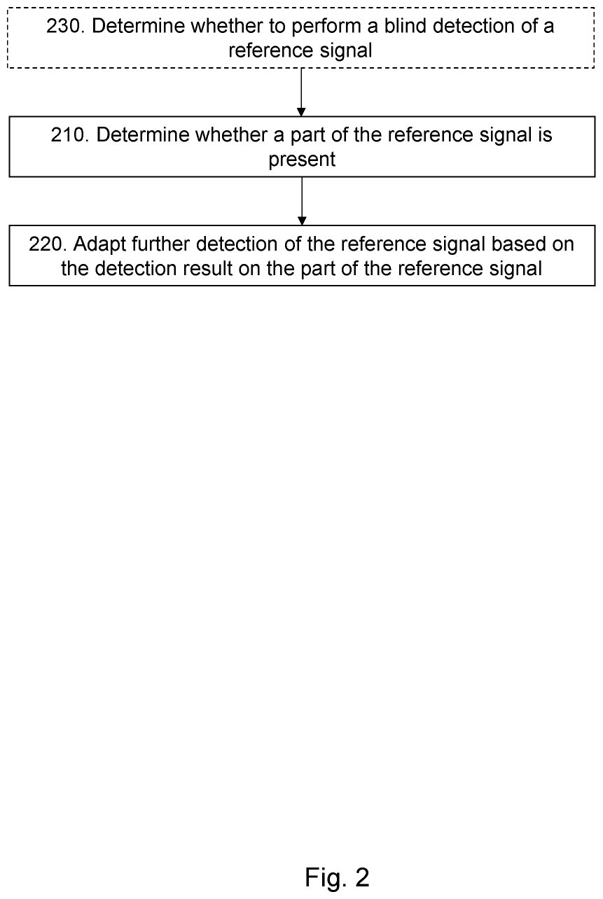

A method performed in a UE 130 according to embodiments herein for blind detection of a reference signal, i.e. to detect whether a reference signal, e.g. TRS/CSI-RS, is transmitted by a network node during reference signal transmission occasions in a wireless communication system 100, will be described with reference to FIG. 2, where the UE 130 is in idle mode and transmissions of reference symbols (RSs) such as TRS, CSI-RS, SSBs, non-SSB RS etc. are provided in the wireless communication system 100. The method comprises the following actions, which actions may be performed in any suitable order.

Action 210

The UE 130 determines whether a part of the reference signal is present. The part of the reference signal comprise any one of a first symbol or a subset of the first symbol resources of the reference signal, a subcarrier of the reference signal, a subset frequency allocations of the reference signal, a part of reference signal with a smaller bandwidth than the total bandwidth of the reference signal, a subset of time or/and frequency resource elements of the reference signal In one embodiment, the UE may employ a subset of T/F resources which are configured for a TRS/CSI-RS signal instead of the full T/F resources for detection. For example, a TRS signal may consist of 4 symbols spanning over two consecutive slots, or at least two symbols within the same slot with 4 symbols distances from each others.

In one approach, a UE, e.g. using a power efficient detecting method, may attempt to detect the reference signal e.g. TRS/CSI-RS in only the first symbol of the TRS/CSI-RS occasion, and if the reference signal TRS is not detected, e.g. based on a detection threshold, the UE can skip buffering or detecting the rest of the symbols of the TRS occasion and thereby lowering the BD power consumption. Here, the UE may additionally consider the processing time required to detect the TRS. For example, if the UE requires 5 symbols, as a time duration and not actual symbols, to process the TRS detection, the UE may skip buffering the 3^{rd} and 4^{th} TRS symbols if the 1^{st} symbol or 2^{nd} symbol of TRS are not detected, but if the UE only requires 3 symbols as duration of time to process TRS detection, then the UE can skip 2^{nd}, 3^{rd} and 4^{th} TRS symbols if the 1^{st} TRS symbol is not detected. In another approach which may also be combined with the previous approach, the UE only looks at a subset of the reference signal frequency allocation, e.g., one subcarrier, or a smaller BW than the total reference signal bandwidth.

Action 220

The UE 130 adapts further detection of the reference signal based on the detection result on the part of the reference signal.

In one embodiment, the UE can adapt the detection strategy based on initial partial detection results. The UE may detect the first symbol and assess the detection probability, e.g. based on a detection metric like the correlator output magnitude. If the metric is below a first threshold, the UE may decide that no reference signal TRS is present and revert to legacy procedures; any further detection is omitted. If the metric is above a second threshold, the UE may decide that the reference signal TRS is present and terminate the BD process and proceed with utilizing the TRS. If the metric is between the first and second thresholds, the UE may collect additional TRS symbols and perform further detection using aggregated samples from multiple symbols. The first and second thresholds may be adapted based on the estimated SINR. In one embodiment, the first threshold may be lower and the second threshold may be higher for lower SINR.

The same principle may be applied after initially detecting 2 or more symbols, or applied progressively as more symbols are collected, where the thresholds may depend on the number of symbols collected.

In a related realization, the UE has an estimate of the channel conditions, e.g., Reference Signal Received Power (RSRP), Reference Signal Received Quality (RSRQ), or SI NR obtained e.g., based on a recent SSB serving cell measurement. Furthermore, the UE may have set a first detection performance which needs to be satisfied, e.g., the missed detection rate for the reference signal TRS/CSI-RS detection should be lower than a first threshold, or the false alarm rate for the reference signal TRS/CSI-RS detection should be lower than a second threshold. Based on the type of employed detector or channel conditions, the UE may decide how much T/F resources are required to attain the first detection performance, with the required T/F resources being lower than the full ones, or full resources contained within the idle mode monitored BW e.g., CORESET0 BW. For example, the UE may note in a high SI NR e.g., SINR of 5 dB, only one resource element (RE) per Physical Resource Block (PRB) is sufficient, or that only detection of the first symbol or a subset of first symbol resources is sufficient. If the SINR is low, e.g., SINR of −5 dB, two symbols or more may be needed to reliably satisfy the first detection performance.

In one embodiment, the number of required REs to achieve required BD reliability may be determined jointly over T- and F-domains, i.e. selecting the receiver BW and the number of symbols that provide the required number REs. The UE may consider multiple combinations of BW and symbols and select the one providing the required number of REs with minimal energy consumption.

In another implementation, the UE may use a different receiver mode, e.g., a low power receiver mode than the normal mode, i.e., the mode used for paging monitoring for TRS detection.

The UE may detect a reference signal based on different methods, e.g., energy detection, which is referred as an energy detector, or TRS feature detection, which is referred as a feature detector. Energy detection is very simple and leads to very low power consumption, nevertheless, it may not be highly reliable in terms of detection performance below a specific SINR, e.g., 0 dB. Additionally, in case the network node does not transmit TRS, it may use TRS resources for other purposes, e.g., data transmission. In this case, the energy detector may detect a signal in TRS resources which is not a TRS, and this leads to a false alarm. Feature detection, e.g. correlating with a reference signal including the known features of the signal to be detected, on the other hand leads to a higher detection performance, though it may need additional power consumption with respect to an energy detector. A feature detector may for example detect specific features in a TRS such as the scrambling code. According some embodiments herein, the UE may implement multiple detectors comprising, e.g. an energy detector, a feature detector or any other type detector, and choose the one to use based on one or more factors such as a SINR threshold, or a specific channel condition, etc.

### Aspect 2: The UE Decision to Blindly Detect TRS/CSI-RS

As mentioned earlier, the BD process itself is energy consuming and if TRS/CSI-RS is not present in a TRS/CSI-RS occasion, this means additional power consumption for the UE relative to the case that the UE does not employ TRS/CSI-RS before a PO monitoring. Therefore, it is important that not only the BD itself is of low power consumption, but that despite the potential cost of BD of TRS/CSI-RS, the UE can still exploit potential TRS/CSI-RS transmissions to achieve overall reduced power consumption in idle mode. Note that in all the embodiments below, it is assumed if TRS is present, then it is more power efficient for the UE to employ the detected TRS as well for preparation before a paging monitoring, e.g., T/F synchronization, Aromatic Gain Control (AGC), etc. The UE can make such determination ahead of time by comparing the energy consumption of legacy- and TRS-aided reception or loop convergence procedures.

Therefore, the method performed in a UE for detection of a reference signal in idle mode in a wireless communication system may further comprise the following action:

Action 230

The UE 130 determines whether to perform a blind detection of a reference signal based on any one or a combination of the associated power consumption of the blind detection, the channel conditions, the probability of a reference signal being present, the presence of a reference signal as a paging early indicator etc.

In one embodiment, the UE decides to employ BD based on the associated power consumption of BD or potentially multiple blind detectors. For example, if the BD power consumption or power consumption of at least one of the blind detectors is lower than a first threshold, then the UE employs BD, but if it is higher, then the UE does not employ BD, where the thresholds may depend on other reception or detection parameters like the number of SSBs required. For example, the UE may be able to implement BD with very low power, e.g., 10 times lower than the normal receiver mode measuring TRS, and thus even its failure in detecting TRS may not lead to a large cost, it is then still beneficial to BD TRS and exploit it for paging monitoring measurement in terms of power saving by reducing the total awake time, while available, and revert to legacy processing if not available. Therefore, BD is not a penalty and it is beneficial to attempt it even if the TRS presence probability may be low and employing TRS can help saving power for PO monitoring. For example, the UE determines based on a condition that it needs one or more SSB measurements before a PO, and if one or more TRS is present in between the SSBs before a PO, then the UE can use those in order to shorten the awake time of the UE, achieve a higher sleeping time and save power.

In another embodiment, the UE may decide to perform BD based on the channel conditions. For example, if SI NR is higher than a specific threshold e.g., 0 dB, then the UE performs BD, but if SI NR is lower than a specific threshold, then it does not. In another implementation, the UE may consider both channel conditions and BD power consumption as described in the previous embodiment to decide whether to perform BD or not. For example, if the BD power consumption is lower than the first threshold, and SI NR is higher than the second threshold, then perform BD.

In another embodiment, the UE is additionally aware of the probability of TRS being present. For example, the UE may have noted that based on previous measurements or an explicit provision from the network node, or in implicit ways, that the chance of TRS being present is X %, e.g., 80%. Implicit ways may be e.g., the network node would not provide the TRS/CSI-RS occasions to the idle UE if the chance of TRS presence is lower than a specific threshold, e.g., 80% or that the network node would not configure the UE to use BD or indicate BD as a way of detecting the availability of TRS for the UE, and alternatively, would explicitly let the UE know when TRS is actually transmitted in idle mode. In another embodiment, the UE may also become aware of a high chance of TRS being present, because a UE is recently paged e.g., in the last PO, and thus there is a high chance that at least one UE is in connected mode which means TRS/CSI-RS being transmitted. Based on a combination of one or more of BD(s) power consumption, channel conditions, the underlying detection performance, or potential power saving gains, the UE may determine a threshold for the probability of TRS presence as a condition to perform BD or not. For example, the UE may note that if the probability of TRS presence is lower than 70%, then the benefits of employing TRS for idle mode power savings diminishes because of BD additional power consumption, and thus if the probability of TRS presence is higher than 70%, then the UE performs BD, but if the probability of TRS presence is lower than 70%, then it does not perform BD.

In another embodiment, the TRS may be used additionally as a paging early indicator. In one example, the UE may evaluate if employing paging early indicator itself provides power saving, i.e., if the UE first tries to detect paging early indicator and then based on the outcome monitor a PO, then it is more power saving than monitoring the PO irrespective of paging early indicator. For example, the UE may note that it needs one or more RS measurements before a PO, and it is additionally configured with a paging early indicator. If the UE only needs one RS, then the UE does not need to monitor paging early indicator necessarily, since it has to measure one RS anyway, and thus it can directly monitor PO. But if it needs two RSs, then it can monitor paging early indicator, and if there is no paging, then avoid measuring the second RS, and thus save power. For another example, the UE may note that the channel conditions are good, e.g., SINR higher than 10 dB, and thus the UE only needs one SSB measurement before a PO, and thus it may be more power efficient to just monitor PO than trying to blindly detect TRS as paging early indicator all the time. Alternatively, if SINR is low, e.g., lower than 0 dB, then the UE may decide to blindly detect TRS as paging early indicator if this leads to saving power at the UE side.

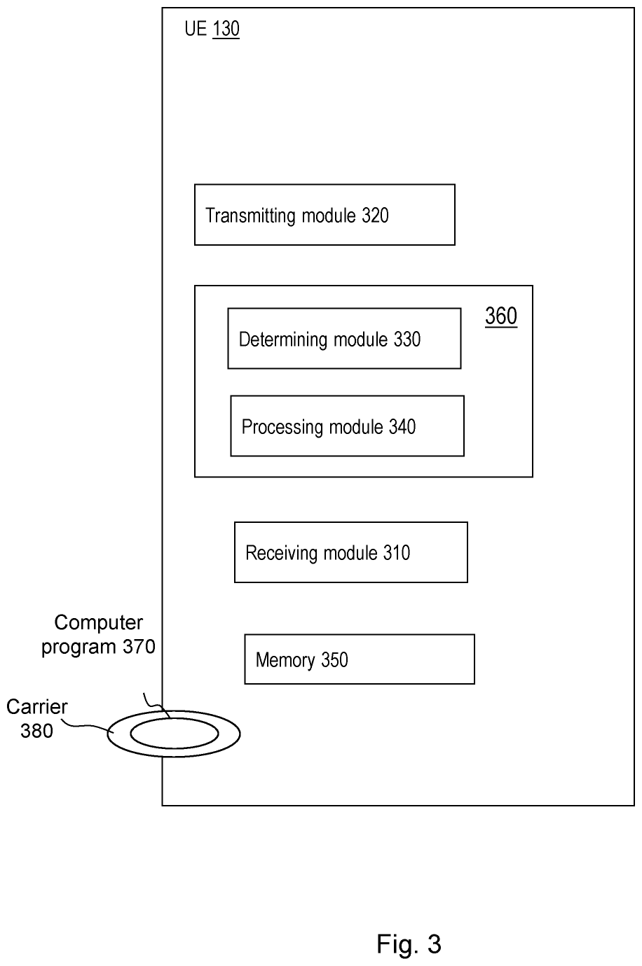

To perform the method in the UE 130, the UE 130 comprises modules as shown in FIG. 3. The UE 130 comprises a receiving module 310, a transmitting module 320, a determining module 330, a processing module 340, a memory 350 etc. The determining module 330 and processing module 340 may be combined as one module, shown as processor 360.

The method according to embodiments herein may be implemented through one or more processors, such as the processor 360 in the UE 130 together with computer program code for performing the functions and actions of the embodiments herein. The program code mentioned above may also be provided as a computer program product, for instance in the form of a data carrier 380 carrying computer program code 370, as shown in FIG. 3, for performing the embodiments herein when being loaded into the UE 130. One such carrier may be in the form of a CD ROM disc. It is however feasible with other data carriers such as a memory stick. The computer program code may furthermore be provided as pure program code on a server or a cloud and downloaded to the UE 130.

The memory 350 in the UE 130 may comprise one or more memory units and may be arranged to be used to store received information, measurements, data, configurations and applications to perform the method herein when being executed in the UE 130.

Some example Embodiments are described below.

Embodiment 1: A method performed in a UE for detection of a reference signal in idle mode in a wireless communication system, the method comprising:
determining whether a part of the reference signal is present, wherein the part of the reference signal comprise any one of a first symbol or a subset of the first symbol resources of the reference signal, a subcarrier of the reference signal, a subset frequency allocations of the reference signal, a part of reference signal with a smaller bandwidth than the total bandwidth of the reference signal, a subset of time or/and frequency resource elements of the reference signal; and
adapting further detection of the reference signal based on the detection result on the part of the reference signal.

Embodiment 2: The method according to Embodiment 1 further comprising:
determining whether to perform a blind detection of a reference signal based on any one or a combination of the associated power consumption of the blind detection, the channel conditions, the probability of a reference signal being present, the presence of a reference signal as a paging early indicator.

Embodiment 3: The method according to any one of Embodiments 1-2, further comprising obtaining information on the probability of a reference signal being present from a network node or based on a pre-configuration or history.

1-14. (canceled)

15. A method performed in a wireless device for detection of a reference signal in idle mode in a wireless communication system, the method comprising:
determining whether a part of the reference signal is present, wherein the part of the reference signal comprise any one of a first symbol or a subset of the first symbol resources of the reference signal, a subcarrier of the reference signal, a subset frequency allocations of the reference signal, a part of reference signal with a smaller bandwidth than the total bandwidth of the reference signal, a subset of time or/and frequency resource elements of the reference signal; and
adapting further detection of the reference signal based on the detection result on the part of the reference signal.

16. The method of claim 15, further comprising:
determining whether to perform a blind detection of a reference signal based on any one or a combination of: the associated power consumption of the blind detection, the channel conditions, the probability of a reference signal being present, and the presence of a reference signal as a paging early indicator.

17. The method of claim 15, comprising
obtaining information on the probability of the reference signal being present from a network node or based on a pre-configuration or history.

18. The method of claim 17, wherein the obtaining of the probability of the reference signal from the network node comprises receiving information on the probability from the network node.

19. The method of claim 18, wherein the received information comprises an indication on a percentage of presence of the time as part of provision of the reference signal occasions.

20. The method of claim 15, wherein the reference signal comprises a periodic Tracking Reference Signal (TRS).

21. The method of claim 15, wherein the reference signal comprises a Channel State Information-Reference Signal (CSI-RS).

22. The method of claim 15, comprising adapting an amount of resource elements to use for detection of the reference signal based on an estimated channel condition.

23. The method of claim 15, wherein the determination whether the part of the reference signal is present comprises detecting energy of the any one of a first symbol or a subset of the first symbol resources of the reference signal, a subcarrier of the reference signal, a subset frequency allocations of the reference signal, a part of reference signal with a smaller bandwidth than the total bandwidth of the reference signal, a subset of time or/and frequency resource elements of the reference signal.

24. The method of claim 15, wherein the determination whether the part of the reference signal is present comprises detecting features of the any one of a first symbol or a subset of the first symbol resources of the reference signal, a subcarrier of the reference signal, a subset frequency allocations of the reference signal, a part of reference signal with a smaller bandwidth than the total bandwidth of the reference signal, a subset of time or/and frequency resource elements of the reference signal.

25. The method of claim 24, wherein the feature detection comprises detection of a scrambling code of the reference signal.

26. The method of claim 15, wherein the reference signal functions as a Paging Early Indicator (PEI) and the method comprises monitoring a paging occasion (PO) upon determining that the PEI is present.

27. The method of claim 26, wherein upon monitoring the PO, the method comprises blindly detecting whether a Tracking Reference Signal (TRS) or a Channel State Information-Reference Signal (CSI-RS) is present.

28. A user equipment (UE), comprising a processor and a receiving module connected to the processor, the processor being configured to cause the UE to:
detemine whether a part of the reference signal is present, wherein the part of the reference signal comprise any one of a first symbol or a subset of the first symbol resources of the reference signal, a subcarrier of the reference signal, a subset frequency allocations of the reference signal, a part of reference signal with a smaller bandwidth than the total bandwidth of the reference signal, a subset of time or/and frequency resource elements of the reference signal; and
adapt further detection of the reference signal based on the detection result on the part of the reference signal.

29. The UE of claim 28, the processor being further configured to cause the UE to:
determine whether to perform a blind detection of a reference signal based on any one or a combination of: the associated power consumption of the blind detection, the channel conditions, the probability of a reference signal being present, and the presence of a reference signal as a paging early indicator.

30. The UE of claim 28, the processor being further configured to cause the UE to:
obtain information on the probability of the reference signal being present from a network node or based on a pre-configuration or history.

31. The UE of claim 30, the processor being configured to cause the UE to obtain the probability of the reference signal from the network node by receiving information on the probability from the network node.

32. The UE of claim 31, wherein the received information comprises an indication on a percentage of presence of the time as part of provision of the reference signal occasions.

33. The UE of claim 28, the processor being configured to cause the UE to determine whether the part of the reference signal is present by detecting energy of the any one of a first symbol or a subset of the first symbol resources of the reference signal, a subcarrier of the reference signal, a subset frequency allocations of the reference signal, a part of reference signal with a smaller bandwidth than the total bandwidth of the reference signal, a subset of time or/and frequency resource elements of the reference signal.

34. The UE of claim 28, the processor being configured to cause the UE to determine whether the part of the reference signal is present by detecting features of the any one of a first symbol or a subset of the first symbol resources of the reference signal, a subcarrier of the reference signal, a subset frequency allocations of the reference signal, a part of reference signal with a smaller bandwidth than the total bandwidth of the reference signal, a subset of time or/and frequency resource elements of the reference signal.
